(19) United States
(12) Patent Application Publication
(10) Pub. No.: US 2014/0205586 A1
(43) Pub. Date: Jul. 24, 2014

(54) CONTROL OF BIOFILM FORMATION

(71) Applicant: THE REGENTS OF THE UNIVERSITY OF MICHIGAN, Ann Arbor, MI (US)

(72) Inventors: Chuanwu Xi, Ann Arbor, MI (US); Jianfeng Wu, Ann Arbor, MI (US)

(73) Assignee: THE REGENTS OF THE UNIVERSITY OF MICHIGAN, Ann Arbor, MI (US)

(21) Appl. No.: 14/248,080

(22) Filed: Apr. 8, 2014

Related U.S. Application Data
(63) Continuation of application No. 13/219,244, filed on Aug. 26, 2011.
(60) Provisional application No. 61/377,779, filed on Aug. 27, 2010.

(51) Int. Cl. A01N 63/02

(52) U.S. Cl. CPC A01N 63/02
USPC 424/94.6

(57) ABSTRACT

The invention relates to control of biofilm development. Specifically, some embodiments of the present invention relate to control of bacterial biofilm formation through addition or breakdown of signal(s) that induce biofilm formation. More specifically, some embodiments of the present invention relate to control (e.g., promotion, prevention) of biofilm development by application or hydrolysis of adenosine triphospate (ATP), deoxyadenosine triphosphate (dATP), or derivatives or analogs thereof (e.g., through application or administration of an agent that hydrolyzes ATP, dATP, or derivatives or analogs thereof (e.g., apyrase)).

### CROSS-REFERENCE TO RELATED APPLICATIONS

The present application is a continuation of U.S. patent application Ser. No. 13/219,244 filed Aug. 26, 2011, which claims priority to U.S. Provisional Patent Application Ser. No. 61/377,779 filed Aug. 27, 2010, each of which are hereby incorporated by reference in its entirety.

### FIELD OF THE INVENTION

The invention relates to control of biofilm development. Specifically, some embodiments of the present invention relate to control of bacterial biofilm formation through addition or breakdown of signal(s) that induce biofilm formation. More specifically, some embodiments of the present invention relate to control (e.g., promotion, prevention) of biofilm development by application or hydrolysis of adenosine triphospate (ATP), deoxyadenosine triphosphate (dATP), or derivatives or analogs thereof (e.g., through application or administration of an agent that hydrolyzes ATP, dATP, or derivatives or analogs thereof (e.g., apyrase)).

### BACKGROUND OF THE INVENTION

A biofilm is a well-organized community of microorganisms that adheres to surfaces and is embedded in the slimy extracellular polymeric substances (EPSs). EPSs are a complex mixture of high-molecular-mass polymers (>10,000 Da) generated by the bacterial cells, cell lysis and hydrolysis products, and organic matter adsorbed from the substrate. EPSs are involved in the establishment of stable arrangements of microorganisms in biofilms (Wolfaardt et al. (1998) Microb. Ecol. 35:213-223; herein incorporated by reference in its entirety), and extracellular DNA (eDNA) is one of the major components of EPSs (Flemming et al. (2001) Water Sci. Technol. 43:9-16; Spoering et al. (2006) Curr. Opin. Microbiol. 9:133-137; each herein incorporated by reference in its entirety). eDNA plays a very important role in biofilm development (Whitchurch et al. (2002) Science 295:1487; herein incorporated by reference in its entirety). It is involved in providing substrates for sibling cells, maintaining the three-dimensional structure of biofilms, and enhancing the exchange of genetic materials (Molin et al. (2003) Curr. Opin. Biotechnol. 13:255-261; Spoering et al. (2006) Curr. Opin. Microbiol. 9:133-137; each herein incorporated by reference in its entirety). Biofilm formation is one of the mechanisms bacteria use to survive in adverse environments (Costerton et al. (1995) Ann. Rev. Microbiol. 49:711-745; Hall-Stoodley et al. (2004) Nat. Rev. Microbiol. 2:95-108; O'Toole et al. (2000) Ann. Rev. Microbiol. 54:49-79; Parsek et al. (2003) Ann. Rev. Microbiol. 57:677-701; each herein incorporated by reference in its entirety). Bacteria living in a biofilm usually have significantly different properties from free-floating (planktonic) bacteria of the same species, as the dense and protected environment of the film allows them to cooperate and interact in various ways. One benefit of this environment is increased resistance to detergents and antibiotics, as the dense extracellular matrix and the outer layer of cells protect the interior of the community. In some cases antibiotic resistance can be increased a thousand-fold (Stewart et al. (2001) Lancet 358:135-138; herein incorporated by reference in its entirety). Biofilms may form in various bacterial species (e.g., Acinetobacter sp. (e.g., A. baylyi, A. baumannii), Staphylococcus aureus, Stenotrophomonas maltophilia, Escherichia coli (e.g., E. coli K-12)). The formation of biofilms in such species is a major determinant of medical outcome during the course of colonization or infection. For example, Acinetobacter spp. frequently colonize patients in clinical settings through formation of biofilms on ventilator tubing, on skin and wound sites, medical tubing, and the like, and are a common cause of nosocomial pneumonia.

As biofilms are complex structures formed of various elements, their removal or disruption traditionally requires the use of dispersants, surfactants, detergents, enzyme formulations, anti-microbials, biocides, boil-out procedures, corrosive chemicals, mechanical cleaning, use of antimicrobial agents, inhibiting microbial attachment, inhibiting biofilm growth by removing essential nutrients and promoting biomass detachment and degradation of biofilm matrix (Chen X S, P.S.: Biofilm removal caused by chemical treatments. Water Res 2000; 34:4229-4233; herein incorporated by reference in its entirety). However, such classical removal or disruption methods are not efficacious or feasible in all situations where biofilm formation is undesirable.

### SUMMARY OF THE INVENTION

The invention relates to biofilm development and control thereof. Specifically, some embodiments of the present invention relate to control of bacterial biofilm formation through addition or breakdown of signal molecules that promote biofilm formation. More specifically, some embodiments of the present invention relate to regulation of biofilm formation by addition or hydrolysis of adenosine triphospate (ATP), deoxyadenosine triphosphate (dATP), derivatives or analogs thereof (e.g., through application or administration of apyrase).

While the present invention is not limited to any particular mechanism, and an understanding of the mechanism is not necessary to practice the present invention, it is contemplated that disruption of signaling that leads to biofilm formation finds use in controlling (e.g., preventing and disruption) the formation of biofilms. In one non-limiting example, signaling by extracellular adenosine 5′-triphosphase (eATP) plays an important role in diverse patho-physiological processes, serving as an intracellular signal in eukaryotes (Burnstock (2006) Parmacol. Rev. 58:58-86; herein incorporated by reference in its entirety) to activate host inflammatory and immune responses (Dando et al. (2009) J. Physiol. 587:5899-5906; Komlosi et al. (2005) Physiology (Bathesda) 20:86-90; Trautmann (2009) Sci. Signal 2:pe6; each herein incorporated by reference in its entirety). While the present invention is not limited to any particular mechanism, and an understanding of the mechanism is not necessary to practice the present invention, it is contemplated that pathogens and other etiological factors can cause distress or injury of host cells wherein stressed or injured cells release ATP via lytic or non-lytic pathways. A rapid increase of ATP concentration in the extracellular space acts as an early and sensitive sign of cellular stress (“danger signal”), alerting the immune system of an impending danger due to exogenous and endogenous causes (Di Virgilio (2007) Purinergic Signal 2:1-3; Di Virgilio et al. (2009) Trends Neurosci. 32:79-87; each herein incorporated by reference in its entirety) to activate the quick inflammatory response to clear invading pathogens. In experiments conducted during the course of developing some embodiments of the present invention, it was discovered that bacteria can sense extracellular dATP/ATP as a “danger signal” and extracellular dATP/ATP induces bacterial cell lysis and eDNA release, resulting in increased bacterial adherence and biofilm formation to protect from activated host innate immunity. In some embodiments of the present invention, these signal molecules are targeted for biofilm control.

In experiments conducted during the development of some embodiments of the present invention, it was found that treatment of Acinetobacter baylyi, S. aureus, and E. coli with exogenous dATP altered establishment and development of biofilms. For example, treatment with dATP stimulated initial attachment of Acinetobacter and accelerated biofilm formation. Conversely, application of apyrase, which hydrolyzes ATP to AMP and inorganic phosphate, caused reduced biofilm biomass.

Accordingly, the present invention provides methods and systems for affecting (e.g., inhibiting, promoting) the formation of biofilms by treatment with ATP, dATP, analogs and derivatives thereof, or agents that affect the level or stability of ATP or dATP. In some embodiments, methods and systems of the present invention find use in facilitating the formation of biofilms, e.g., where biofilm formation is desirable, e.g., by application of ATP, dATP, or analogs or derivatives thereof. In some embodiments, methods and systems of the present invention find use in inhibiting formation or development of biofilms, e.g., by application of agent(s) that affect the stability, incidence, or level of ATP, dATP, or derivatives or analogs thereof.

In some embodiments, the present invention involves the application of an agent that degrades (e.g., hydrolyzes) ATP, dATP, or an analog or derivative thereof. In some embodiments, the agent that degrades (e.g., hydrolyzes) ATP, dATP, or an analog or derivative thereof is apyrase (EC 3.6.1.5), without regard to the source of apyrase (e.g., purified, recombinant, synthetic) or type of apyrase (e.g., wild-type, mutant, chimeric, truncated, of a type found in nature or a type not naturally occurring). The effective dose of apyrase may vary according to the activity level (e.g., specific activity) and the type of application (e.g., surface to which is it applied, formulation, temporal aspects of application, etc.). The level of apyrase applied may be less than 0.5 μM, 0.5-1 μM, 1-10 μM, 10-25 μM, 25-100 μM, 100-500 μM, 0.5-1.0 mM, 1-5 mM, 5-10 mM, 10 mM or higher. Where expressed as mU/ml, the level of apyrase applied may be less than 10 mU/mL, 10-50 mU/mL, 50-100 mU/mL, 100-200 mU/mL, 200-400 mU/mL, 400-600 mU/mL, 600-800 mU/mL, 800-1000 mU/mL, over 1000 mU/mL. In some preferred embodiments, the range is 200-400 mU/mL apyrase. In some embodiments, the level of apyrase is 400 mU/mL. In some embodiments, the agent that degrades ATP, dATP, an analog or derivative thereof (e.g., apyrase) is applied to an inert surface (e.g., including but not limited to a medical device surface, medical tubing, medical instrument, ventilator tubing, dressing or bandage material, storage vessel, container, surgical operating surface, food preparation surface, manufacturing surface). In some embodiments, the agent that degrades ATP, dATP, an analog or derivative thereof (e.g., apyrase) is applied to a living surface (e.g., including but not limited to skin, hair, teeth, fur, wound site, cells, tissues, organs, bodily fluids, blood, plasma, serum, cellular sample, acellular sample). In some embodiments, the level of agent that inhibits (e.g., hydrolyzes) dATP, ATP, analogs or derivatives thereof (e.g., apyrase) that finds use as an effective dose is determined by the type of application (e.g., topical, type of surface to which it is applied, formulation (e.g., semisolid, solid, liquid, gaseous), temporal aspects of application). In some embodiments, other agent(s) that hydrolyze ATP, dATP, or analogs or derivatives thereof are used. For example, numerous enzymes comprise ATP hydrolysis domains. Such enzymes include but are not limited to myosin, dynein, SufC, topoisomerase II, actin, Hsp90, and numerous other ATPases (e.g., E.C. 3.6.3 and 3.6.4 and subclasses therein) (e.g., enzymes classified as F-ATPases, V-ATPases, A-ATPases, P-ATPases, E-ATPases).

In some embodiments, the present invention involves the application of dATP, ATP, derivatives or analogs thereof to affect biofilms (e.g., biofilm development, formation, initiation). In some embodiments, the level of dATP, ATP, analogs or derivatives thereof is less than 10 μM, 10-25 μM, 25-50 μM, 50-100 μM, 100-250 μM, 250-500 μM, 500-1000 μM, 1 mM or above. In some preferred embodiments, the range is 250-500 μM. In some embodiments, the level of dATP, ATP, analogs or derivatives thereof that finds use as an effective dose is determined by the type of application (e.g., topical, type of surface to which it is applied, formulation (e.g., semisolid, solid, liquid, gaseous), temporal aspects of application). In some embodiments, ATP, dATP, an analog or derivative thereof is applied to an inert surface (e.g., including but not limited to a medical device surface, medical tubing, ventilator tubing, dressing or bandage material, storage vessel, container, operating surface, food preparation surface, manufacturing surface). In some embodiments, ATP, dATP, an analog or derivative thereof is applied to a living surface (e.g., including but not limited to skin, hair, fur, wound site, cells, tissues, organs, bodily fluids, blood, plasma, serum, cellular sample, acellular sample).

Methods and systems of the present invention are not limited by temporal aspects of treatment, e.g., whether treatment occurs once, repeatedly, intermittently, for prolonged periods or for a limited period. In some embodiments, stabilized forms of the active agent (e.g., apyrase; dATP, ATP, an analog or derivative thereof) are used (e.g., as incorporated into a coating) for continual prevention of biofilm formation as a prophylactic measure. In some embodiments, an agent affecting stability or level of dATP, ATP, an analog or derivative thereof is co-administered with another agent (e.g., an antibiotic, a bacteriostatic agent, an antiseptic agent).

Methods and systems of the present invention are not limited by the species (e.g., bacterial species) to which the treatment is directed. Species include but are not limited to Acinetobacter sp. (e.g., A. baylyi, A. baumannii), Staphylococcus aureus, Stenotrophomonas maltophilia, Escherichia coli (e.g., E. coli K-12). The present invention is not limited by the formulation of the active agent, e.g., an agent that degrades (e.g., hydrolyzes) ATP, dATP, or an analog or derivative thereof (e.g., apyrase) or an agent that affects the level of ATP or dATP (e.g., ATP or dATP itself, a derivative or analog thereof).

In certain embodiments, the present invention provides a method for inhibiting biofilm development comprising contacting microbes with an agent that hydrolyzes a compound such as ATP, dATP, an analog of ATP, or a derivative of ATP under conditions such that reduced biofilm formation occurs relative to a microbe not contacted with the agent. In some embodiments, the agent is apyrase. In some embodiments, a microbe is selected from any suitable bacterium, including: aerobic or non-aerobic, gram-positive or gram-negative, motile or non-motile, etc. In some embodiments, the microbes are a type such as Acinetobacter baylyi, Acinetobacter baumannii, Staphylococcus aureus, Stenotrophomonas maltophilia, or Eschericheria coli. However, the present invention is not limited by the type of microbe. In some embodiments, the apyrase is administered at a concentration of at least 200 mU/mL. In some embodiments, the agent is administered to a patient. In some embodiments, administration occurs by a route such as oral, intravenous, intraperitoneal, intramuscular, transdermal, subcutaneous, topical, sublingual, or rectal. In some embodiments, contacting comprises incorporating the agent into a surface that contacts the microbe. In some embodiments, the surface is the surface of an object such as a medical device, a medical instrument, a dressing, a bandage, a food preparation surface, a food packaging surface, a manufacturing surface, a consumer good, a water treatment system, a water delivery system, or a ventilation system.

In certain embodiments, the present invention provides a method for inhibiting or preventing attachment of a biofilm-forming microbe comprising contacting a microbe with an agent that hydrolyzes a compound such as ATP, dATP, an analog of ATP, or a derivative of ATP such that attachment of said microbes to said surface is inhibited or prevented. In some embodiments, the agent is apyrase. In some embodiments, contacting comprises incorporating the agent into a surface that contacts the microbe.

In certain embodiments, the present invention provides a method of inhibiting biofilm formation at a wound site comprising contacting the wound site with an agent that hydrolyzes a compound such as ATP, dATP, an analog of ATP, or a derivative of ATP under conditions such that the formation of the biofilm is inhibited or prevented. In some embodiments, the agent is apyrase. In some embodiments, the agent is a component of a wound-contacting material such as a dressing, a gel, an ointment, a bandage, a solution, a cream, a salve, or a spray.

In certain embodiments, the present invention provides a method for promoting biofilm development comprising contacting a microbe with an agent such as ATP, dATP, an analog of ATP, or a derivative of ATP such that a biofilm develops. In some embodiments, the contacting comprises incorporating the agent into a surface that contacts the microbe.

In some embodiments, the present invention provides methods for inhibiting or preventing biofilm formation and/or attachment of biofilm-forming microbes to a surface comprising contacting a microbe with an agent that hydrolyzes a compound selected from the group consisting of ATP, dATP, an analog of ATP, and a derivative of ATP under conditions such that reduced biofilm formation occurs relative to a microbe not contacted with said agent. In some embodiments, the agent is apyrase. In some embodiments, a microbe is selected from any suitable bacterium, including: aerobic or non-aerobic, gram-positive or gram-negative, motile or non-motile, etc. In some embodiments, the microbes are a type such as Acinetobacter baylyi, Acinetobacter baumannii, Staphylococcus aureus, Stenotrophomonas maltophilia, or Eschericheria coli. However, the present invention is not limited by the type of microbe. In some embodiments, the apyrase is administered at a concentration of at least 200 mU/mL. In some embodiments, the agent is administered to a patient. In some embodiments, administration occurs by a route selected from the group consisting of oral, intravenous, intraperitoneal, intramuscular, transdermal, subcutaneous, topical, sublingual, and rectal. In some embodiments, contacting comprises incorporating said agent into said surface, and said surface contacts said microbe. In some embodiments, the surface that contacts said microbe is the surface of an object selected from the group consisting of a medical device, a medical instrument, a dressing, a bandage, a food preparation surface, a food packaging surface, a manufacturing surface, a consumer good, a water treatment system, a water delivery system, and a ventilation system. In some embodiments, the surface comprises a wound. In some embodiments, the agent is a component of a wound-contacting material selected from the group consisting of a dressing, a gel, an ointment, a bandage, a solution, a cream, a salve, and a spray.

In some embodiments, the present invention provides methods for promoting biofilm development comprising contacting a microbe with an agent selected from the group consisting of ATP, dATP, an analog of ATP, and a derivative of ATP such that a biofilm develops. In some embodiments, contacting comprises incorporating said agent into a surface that contacts said microbe.

In certain embodiments, the present invention provides a kit for inhibiting biofilm development, the kit comprising an agent that hydrolyzes a compound such as ATP, dATP, an analog of ATP, or a derivative of ATP; and a kit component such as a dressing, a gel, an ointment, a bandage, a solution, a cream, a salve, or a spray. In some embodiments, the present invention provides a kit for altering biofilm development, said kit comprising: (a) an agent that alters the local level of ATP, dATP, an analog of ATP, and a derivative of ATP; and b) a carrier composition for application of said agent. In some embodiments, the agent hydrolyzes a compound selected from the group consisting of ATP, dATP, an analog of ATP, and a derivative of ATP. In some embodiments, the agent is apyrase. In some embodiments, the agent comprises ATP, dATP, an analog of ATP, and a derivative of ATP. In some embodiments, the carrier is selected from the group consisting of a dressing, a gel, an ointment, a bandage, a solution, a cream, a salve, and a spray. In some embodiments, the carrier is selected from the group consisting of a medical device, a medical instrument, a dressing, a bandage, a food preparation surface, a food packaging surface, a manufacturing surface, a consumer good, a water treatment system, a water delivery system, and a ventilation system.

In some embodiments, the present invention provides the use of an agent that hydrolyzes ATP, dATP, an analog of ATP, or a derivative of ATP (e.g., apyrase) as a medicament or for preventing, reducing, or eliminating biofilm formation on surfaces (e.g., medical device surfaces). In some embodiments, the present invention provides an agent that hydrolyzes ATP, dATP, an analog of ATP, or a derivative of ATP (e.g., apyrase) for use as a medicament for the treatment of biofilms or biofilm-associated infections (infections associated with organisms that can generate biofilms or reside in biofilms).

Additional embodiments will be apparent to persons skilled in the relevant art based on the teachings contained herein.

### DESCRIPTION OF THE DRAWINGS

FIG. 1 shows the effect of dATP or apyrase treatment on biofilm biomass in Acinetobacter biofilm development. Biofilm biomass was quantified using Crystal Violet staining method.

FIG. 2 shows confocal laser scanning micrographs of biofilms developed by E. coli K-12 in 10% LB broth (panel A) or in 10% LB broth supplemented with different reagents: dATP (400 μM) (panel B), DNase I (40 U/ml) (panel C); and Apyrase (200 mU/ml) (panel D).

FIG. 3 shows impact of dATP (400 μM) on bacterial growth (upper panel) and biofilm development by different bacterial strains including S. aureus, S. maltophilia, E. coli, and A. baylyi.

FIG. 4 shows that dATP treatment stimulates Acinetobacter initial attachment during biofilm formation.

FIG. 5 shows that dATP treatment stimulates programmed cell death during Acinetobacter biofilm development. Cross-section images of reconstructed 3-D biofilm structures (panel A) and quantization of programmed cell death by using Cytotox-glo Assay (panel B).

FIG. 6 shows that dATP treatment increases release of extracellular DNA (eDNA) during Acinetobacter biofilm development.

FIG. 7 shows the effects of dATP and apyrase on adherence of A. baumannii to human bronchial epithelial NCI-H292 cells. (A) Number of A. baumannii cells adhered to the monolayer of 100 human bronchial epithelial NCI-H292 cells after 1 hour incubation at 37° C. with 5% (v/v) CO₂ in the RPMI 1640 medium with different treatments: Control (no treatment); dATP (medium supplemented 400 μM of dATP; Apryase (medium supplemented with 200 mU/ml of Apyrase; Damage (around 5% of a monolayer of the epithelial cells was damaged); and a combination of two treatments. Three independent experiments were performed for each treatment and standard deviations of three treatments were included. Representative light micrograph of A. baumannii cells adhered to the epithelial cells after incubation in the RPMI 1640 medium without supplementing dATP (B) and with supplementing dATP (C). (Objective 60×).

FIG. 8 shows results of an Acinetobacter baumannii adherence assay in a mouse wound infection model in presence or absence of apyrase.

### Definitions

To facilitate an understanding of the present invention, a number of terms and phrases are defined below:

As used herein the term “biofilm” refers to any three-dimensional, matrix-encased microbial community displaying multicellular characteristics. Accordingly, as used herein, the term biofilm includes surface-associated biofilms as well as biofilms in suspension, such as flocs and granules. Biofilms may comprise a single microbial species or may be mixed species complexes, and may include bacteria as well as fungi, algae, protozoa, or other microorganisms.

As used herein, the term “extracellular DNA” or “eDNA” refers to deoxyribonucleic acid existing outside (exterior to) the plasma membrane of an organism, e.g., a microorganism (e.g., bacterium) without regard the length of the DNA molecule, the composition of the DNA molecule, or the means by which it localized to an extracellular region.

As used herein, the term “apyrase” refers to any enzyme that hydrolyzes ATP to release AMP and phosphate, without regard to the origin or type of the enzyme (e.g., purified, recombinant, existing in nature, engineered, truncated, mutated).

As used herein, the term “ATP derivative” refers to a compound that is chemically or enzymatically produced from ATP. An ATP derivative may retain all or a portion of the functionality and/or reactivity of ATP, and/or may have additional reactive and functional properties. As used herein, the term “ATP analogue” refers to a compound that is structurally similar to ATP. An ATP analogue may have similar or disparate chemical, physical, and/or functional properties to ATP. A compound may be an ATP derivative, an ATP analogue, both, or neither. Non-limiting examples of ATP analogues and/or ATP derivatives are discussed in Bagshaw (2000) J Cell Sci 114, 459-460 and the accompanying poster insert, both of which are herein incorporated by reference in their entireties.

As used herein, the term “subject” refers to individuals (e.g., human, animal, or other organism) to be treated by the methods or compositions of the present invention. Subjects include, but are not limited to, mammals (e.g., murines, simians, equines, bovines, porcines, canines, felines, and the like), and most preferably includes humans. In the context of the invention, the term “subject” generally refers to an individual who will receive or who has received treatment (e.g., administration of an agent affecting the level or stability of ATP, dATP, a derivative or analog thereof, e.g., apyrase) for a condition characterized by the presence of biofilm-forming bacteria, or in anticipation of possible exposure to biofilm-forming bacteria.

The term “diagnosed,” as used herein, refers to the recognition of a disease (e.g., caused by the presence of biofilm-forming bacteria) by its signs and symptoms (e.g., resistance to conventional therapies), or genetic analysis, pathological analysis, histological analysis, and the like.

As used herein the term, “in vitro” refers to an artificial environment and to processes or reactions that occur within an artificial environment. In vitro environments include, but are not limited to, test tubes and cell cultures. The term “in vivo” refers to the natural environment (e.g., an animal or a cell) and to processes or reaction that occur within a natural environment.

As used herein, the term “virulence” refers to the degree of pathogenicity of a microorganism, e.g., as indicated by the severity of the disease produced or its ability to invade the tissues of a subject. It is generally measured experimentally by the median lethal dose (LD₅₀) or median infective dose (ID₅₀). The term may also be used to refer to the competence of any infectious agent to produce pathologic effects.

As used herein, the term “effective amount” refers to the amount of a composition (e.g., a composition affecting the level or stability of ATP, dATP, a derivative or analog thereof, e.g., apyrase) sufficient to effect beneficial or desired results. An effective amount can be administered in one or more administrations, applications or dosages and is not intended to be limited to a particular formulation or administration route.

As used herein, the term “administration” refers to the act of giving a drug, prodrug, or other agent, or therapeutic treatment (e.g., compositions of the present invention) to a physiological system (e.g., a subject or in vivo, in vitro, or ex vivo cells, tissues, and organs). Exemplary routes of administration to the human body can be through the eyes (ophthalmic), mouth (oral), skin (transdermal), nose (nasal), lungs (inhalant), oral mucosa (buccal), ear, by injection (e.g., intravenously, subcutaneously, intratumorally, intraperitoneally, etc.) and the like.

As used herein, the term “treating a surface” refers to the act of exposing a surface to one or more compositions of the present invention. Methods of treating a surface include, but are not limited to, spraying, misting, submerging, and coating.

As used herein, the term “co-administration” refers to the administration of at least two agent(s) (e.g., two separate agents affecting the level or stability of ATP, dATP, a derivative or analog thereof; or one such agent in combination with an antibiotic) or therapies to a subject. In some embodiments, the co-administration of two or more agents or therapies is concurrent. In other embodiments, a first agent/therapy is administered prior to a second agent/therapy. Those of skill in the art understand that the formulations and/or routes of administration of the various agents or therapies used may vary. The appropriate dosage for co-administration can be readily determined by one skilled in the art. In some embodiments, when agents or therapies are co-administered, the respective agents or therapies are administered at lower dosages than appropriate for their administration alone. Thus, co-administration is especially desirable in embodiments where the co-administration of the agents or therapies lowers the requisite dosage of a potentially harmful (e.g., toxic) agent(s).

As used herein, the term “wound” refers broadly to injuries to tissue including the skin, subcutaneous tissue, muscle, bone, and other structures initiated in different ways, for example, surgery, (e.g., open post cancer resection wounds, including but not limited to, removal of melanoma and breast cancer etc.), contained post operative surgical wounds, pressure sores (e.g., from extended bed rest) and wounds induced by trauma. As used herein, the term “wound” is used without limitation to the cause of the wound, be it a physical cause such as bodily positioning as in bed sores or impact as with trauma or a biological cause such as disease process, aging process, obstetric process, or any other manner of biological process. Wounds caused by pressure may also be classified into one of four grades depending on the depth of the wound: i) Grade I: wounds limited to the epidermis; ii) Grade II: wounds extending into the dermis; iii) Grade III: wounds extending into the subcutaneous tissue; and iv) Grade IV: wounds wherein bones are exposed (e.g., a bony pressure point such as the greater trochanter or the sacrum). The term “partial thickness wound” refers to wounds that are limited to the epidermis and dermis; a wound of any etiology may be partial thickness. The term “full thickness wound” is meant to include wounds that extend through the dermis.

As used herein, “wound site” refers broadly to the anatomical location of a wound, without limitation.

As used herein, the term “acute wound” refers to a wound that has not healed within 30 days.

As used herein, the term “chronic wound” refers to a wound that has not healed in a time period greater than 30 days.

As used herein, the term “dressing” refers broadly to any material applied to a wound for protection, absorbance, drainage, treatment, etc. Numerous types of dressings are commercially available, including films (e.g., polyurethane films), hydrocolloids (hydrophilic colloidal particles bound to polyurethane foam), hydrogels (cross-linked polymers containing about at least 60% water), foams (hydrophilic or hydrophobic), calcium alginates (nonwoven composites of fibers from calcium alginate), and cellophane (cellulose with a plasticizer) (Kannon and Garrett (1995) Dermatol. Surg. 21: 583-590; Davies (1983) Burns 10: 94; each herein incorporated by reference). The present invention also contemplates the use of dressings impregnated with pharmacological compounds (e.g., antibiotics, antiseptics, thrombin, analgesic compounds, etc). Cellular wound dressings include commercially available materials such as Apligraf®, Dermagraft®, Biobrane®, TransCyte®, Integra® Dermal Regeneration Template®, and OrCell®.

As used herein, the term “toxic” refers to any detrimental or harmful effects on a subject, a cell, or a tissue as compared to the same cell or tissue prior to the administration of the toxicant.

As used herein, the term “pharmaceutical composition” refers to the combination of an active agent (e.g., an agent affecting the level or stability of ATP, dATP, an analog or derivative thereof, e.g., apyrase) with a carrier, inert or active, making the composition especially suitable for diagnostic or therapeutic use in vitro, in vivo or ex vivo.

The terms “pharmaceutically acceptable” or “pharmacologically acceptable,” as used herein, refer to compositions that do not substantially produce adverse reactions, e.g., toxic, allergic, or immunological reactions, when administered to a subject.

As used herein, the term “topically” refers to application of the compositions of the present invention to the surface of the skin and mucosal cells and tissues (e.g., alveolar, buccal, lingual, masticatory, or nasal mucosa, and other tissues and cells which line hollow organs or body cavities).

As used herein, the term “pharmaceutically acceptable carrier” refers to any of the standard pharmaceutical carriers including, but not limited to, phosphate buffered saline solution, water, emulsions (e.g., such as an oil/water or water/oil emulsions), and various types of wetting agents, any and all solvents, dispersion media, coatings, sodium lauryl sulfate, isotonic and absorption delaying agents, disintrigrants (e.g., potato starch or sodium starch glycolate), and the like. The compositions also can include stabilizers and preservatives. For examples of carriers, stabilizers, and adjuvants. (See e.g., Martin, Remington's Pharmaceutical Sciences, 15th Ed., Mack Publ. Co., Easton, Pa. (1975), incorporated herein by reference). In certain embodiments, the compositions of the present invention may be formulated for veterinary, horticultural or agricultural use. Such formulations include dips, sprays, seed dressings, stem injections, sprays, and mists. In certain embodiments, compositions of the present invention may be used in any application where it is desirable to alter (e.g., inhibit) the formation of biofilms, e.g., food industry applications; consumer goods (e.g., medical goods, goods intended for consumers with impaired or developing immune systems (e.g., infants, children, elderly, consumers suffering from disease or at risk from disease), and the like.

As used herein, the term “pharmaceutically acceptable salt” refers to any salt (e.g., obtained by reaction with an acid or a base) of a compound of the present invention that is physiologically tolerated in the target subject (e.g., a mammalian subject, and/or in vivo or ex vivo, cells, tissues, or organs). “Salts” of the compounds of the present invention may be derived from inorganic or organic acids and bases. Examples of acids include, but are not limited to, hydrochloric, hydrobromic, sulfuric, nitric, perchloric, fumaric, maleic, phosphoric, glycolic, lactic, salicylic, succinic, toluene-p-sulfonic, tartaric, acetic, citric, methanesulfonic, ethanesulfonic, formic, benzoic, malonic, sulfonic, naphthalene-2-sulfonic, benzenesulfonic acid, and the like. Other acids, such as oxalic, while not in themselves pharmaceutically acceptable, may be employed in the preparation of salts useful as intermediates in obtaining the compounds of the invention and their pharmaceutically acceptable acid addition salts.

Examples of bases include, but are not limited to, alkali metal (e.g., sodium) hydroxides, alkaline earth metal (e.g., magnesium) hydroxides, ammonia, and compounds of formula NW₄⁺, wherein W is C₁₋₄ alkyl, and the like.

Examples of salts include, but are not limited to: acetate, adipate, alginate, aspartate, benzoate, benzenesulfonate, bisulfate, butyrate, citrate, camphorate, camphorsulfonate, cyclopentanepropionate, digluconate, dodecylsulfate, ethanesulfonate, fumarate, flucoheptanoate, glycerophosphate, hemisulfate, heptanoate, hexanoate, chloride, bromide, iodide, 2-hydroxyethanesulfonate, lactate, maleate, methanesulfonate, 2-naphthalenesulfonate, nicotinate, oxalate, palmoate, pectinate, persulfate, phenylpropionate, picrate, pivalate, propionate, succinate, tartrate, thiocyanate, tosylate, undecanoate, and the like. Other examples of salts include anions of the compounds of the present invention compounded with a suitable cation such as Na⁺, NH₄⁺, and NW₄⁺ (wherein W is a C₁₋₄ alkyl group), and the like. For therapeutic use, salts of the compounds of the present invention are contemplated as being pharmaceutically acceptable. However, salts of acids and bases that are non-pharmaceutically acceptable may also find use, for example, in the preparation or purification of a pharmaceutically acceptable compound.

For therapeutic use, salts of the compounds of the present invention are contemplated as being pharmaceutically acceptable. However, salts of acids and bases that are non-pharmaceutically acceptable may also find use, for example, in the preparation or purification of a pharmaceutically acceptable compound.

As used herein, the term “medical devices” includes any material or device that is used on, in, or through a subject's or patient's body, for example, in the course of medical treatment (e.g., for a disease or injury). Medical devices include, but are not limited to, such items as medical implants, wound care devices, drug delivery devices, and body cavity and personal protection devices. The medical implants include, but are not limited to, urinary catheters, intravascular catheters, dialysis shunts, wound drain tubes, skin sutures, vascular grafts, implantable meshes, intraocular devices, heart valves, and the like. Wound care devices include, but are not limited to, general wound dressings, biologic graft materials, tape closures and dressings, and surgical incise drapes. Drug delivery devices include, but are not limited to, needles, drug delivery skin patches, drug delivery mucosal patches and medical sponges. Body cavity and personal protection devices, include, but are not limited to, tampons, sponges, surgical and examination gloves, contact lenses, and toothbrushes. Birth control devices include, but are not limited to, intrauterine devices (IUDs), diaphragms, and condoms.

As used herein, the term “therapeutic agent,” refers to compositions that decrease the infectivity, morbidity, or onset of mortality in a subject contacted by a biofilm-forming microorganism or that prevent infectivity, morbidity, or onset of mortality in a host contacted by a biofilm-forming microorganism. As used herein, therapeutic agents encompass agents used prophylactically, e.g., in the absence of a biofilm-forming organism, in view of possible future exposure to a biofilm-forming organism. Such agents may additionally comprise pharmaceutically acceptable compounds (e.g., adjuvants, excipients, stabilizers, diluents, and the like). In some embodiments, the therapeutic agents of the present invention are administered in the form of topical compositions, injectable compositions, ingestible compositions, and the like. When the route is topical, the form may be, for example, a solution, cream, ointment, salve or spray.

As used herein, the term “pathogen” refers to a biological agent that causes a disease state (e.g., infection, cancer, etc.) in a host. “Pathogens” include, but are not limited to, viruses, bacteria, archaea, fungi, protozoans, mycoplasma, prions, and parasitic organisms.

As used herein, the term “microbe” refers to a microorganism and is intended to encompass both an individual organism, or a preparation comprising any number of the organisms.

As used herein, the term “microorganism” refers to any species or type of microorganism, including but not limited to, bacteria, archaea, fungi, protozoans, mycoplasma, and parasitic organisms.

As used herein, the term “fungi” is used in reference to eukaryotic organisms such as the molds and yeasts, including dimorphic fungi.

The terms “bacteria” and “bacterium” refer to all prokaryotic organisms, including those within all of the phyla in the Kingdom Procaryotae. It is intended that the term encompass all microorganisms considered to be bacteria including Mycoplasma, Chlamydia, Actinomyces, Streptomyces, and Rickettsia. All forms of bacteria are included within this definition including cocci, bacilli, spirochetes, spheroplasts, protoplasts, etc. Also included within this term are prokaryotic organisms that are Gram-negative or Gram-positive. “Gram-negative” and “Gram-positive” refer to staining patterns with the Gram-staining process, which is well known in the art. (See e.g., Finegold and Martin, Diagnostic Microbiology, 6th Ed., C V Mosby St. Louis, pp. 13-15 (1982)). “Gram-positive bacteria” are bacteria that retain the primary dye used in the Gram-stain, causing the stained cells to generally appear dark blue to purple under the microscope. “Gram-negative bacteria” do not retain the primary dye used in the Gram-stain, but are stained by the counterstain. Thus, Gram-negative bacteria generally appear red. The term “non-pathogenic bacteria” or “non-pathogenic bacterium” includes all known and unknown non-pathogenic bacterium (Gram-positive or Gram-negative) and any pathogenic bacterium that has been mutated or converted to a non-pathogenic bacterium. Furthermore, a skilled artisan recognizes that some bacteria may be pathogenic to specific species and non-pathogenic to other species; thus, these bacteria can be utilized in the species in which it is non-pathogenic or mutated so that it is non-pathogenic.

As used herein, the term “non-human animals” refers to all non-human animals including, but are not limited to, vertebrates such as rodents, non-human primates, ovines, bovines, ruminants, lagomorphs, porcines, caprines, equines, canines, felines, ayes, etc.

As used herein, the term “cell culture” refers to any in vitro culture of cells, including, e.g., prokaryotic cells and eukaryotic cells. Included within this term are continuous cell lines (e.g., with an immortal phenotype), primary cell cultures, transformed cell lines, finite cell lines (e.g., non-transformed cells), bacterial cultures in or on solid or liquid media, and any other cell population maintained in vitro.

As used, the term “eukaryote” refers to organisms distinguishable from “prokaryotes.” It is intended that the term encompass all organisms with cells that exhibit the usual characteristics of eukaryotes, such as the presence of a true nucleus bounded by a nuclear membrane, within which lie the chromosomes, the presence of membrane-bound organelles, and other characteristics commonly observed in eukaryotic organisms. Thus, the term includes, but is not limited to such organisms as fungi, protozoa, and animals (e.g., humans).

As used herein, the term “kit” refers to any delivery system for delivering materials. In the context of reaction materials such as an agent that affects the level or stability of ATP, dATP, a derivative or analog thereof (e.g., apyrase), such delivery systems include but are not limited to systems that allow for the storage, transport, or delivery of appropriate reagents (e.g., apyrase, cells, buffers, culture media, selection reagents, etc., in the appropriate containers) and/or devices (e.g., catheters, syringes, reaction tubes or plates, culture tubes or plates) and/or supporting materials (e.g., media, written instructions for performing using the materials, etc.) from one location to another. For example, kits include one or more enclosures (e.g., boxes, bags) containing the relevant reaction reagents and/or supporting materials. As used herein, the term “fragmented kit” refers to delivery systems comprising two or more separate containers that each contains a subportion of the total kit components. The containers may be delivered to the intended recipient together or separately. For example, a first container may contain a dried composition (e.g., lyophilized apyrase, lyophilized dATP) with a gelling agent for a particular use, while a second container contains sterile fluid such as water or buffer for dissolving or resuspending a dried composition. The term “fragmented kit” is intended to encompass kits containing Analyte Specific Reagents (ASR's) regulated under section 520(e) of the Federal Food, Drug, and Cosmetic Act, but are not limited thereto. Indeed, any delivery system comprising two or more separate containers that each contains a subportion of the total kit components are included in the term “fragmented kit.” In contrast, a “combined kit” refers to a delivery system containing all of the components of a reaction materials needed for a particular use in a single container (e.g., in a single box housing each of the desired components). The term “kit” includes both fragmented and combined kits.

As used herein, the terms “a” and “an” means at least one, and may refer to more than one.

The term “coating” as used herein refers to a layer of material covering, e.g., a medical device or a portion thereof. A coating can be applied to the surface or impregnated within the material of the implant.

As used herein, the term “antimicrobial agent” refers to composition that decreases, prevents or inhibits the growth of bacterial and/or fungal organisms. Examples of antimicrobial agents include, e.g., antibiotics and antiseptics.

The term “antiseptic” as used herein is defined as an antimicrobial substance that inhibits the action of microorganisms, including but not limited to alpha.-terpineol, methylisothiazolone, cetylpyridinium chloride, chloroxyleneol, hexachlorophene, chlorhexidine and other cationic biguanides, methylene chloride, iodine and iodophores, triclosan, taurinamides, nitrofurantoin, methenamine, aldehydes, azylic acid, silver, benzyl peroxide, alcohols, and carboxylic acids and salts. One skilled in the art is cognizant that these antiseptics can be used in combinations of two or more to obtain a synergistic effect. Some examples of combinations of antiseptics include a mixture of chlorhexidine, chlorhexidine and chloroxylenol, chlorhexidine and methylisothiazolone, chlorhexidine and (.alpha.-terpineol, methylisothiazolone and alpha.-terpineol; thymol and chloroxylenol; chlorhexidine and cetylpyridinium chloride; or chlorhexidine, methylisothiazolone and thymol. These combinations provide a broad spectrum of activity against a wide variety of organisms.

The term “antibiotics” as used herein is defined as a substance that inhibits the growth of microorganisms without damage to the host. For example, the antibiotic may inhibit cell wall synthesis, protein synthesis, nucleic acid synthesis, or alter cell membrane function.

Classes of antibiotics include, but are not limited to, macrolides (e.g., erythromycin), penicillins (e.g., nafcillin), cephalosporins (e.g., cefazolin), carbepenems (e.g., imipenem), monobactam (e.g., aztreonam), other beta-lactam antibiotics, beta-lactam inhibitors (e.g., sulbactam), oxalines (e.g. linezolid), aminoglycosides (e.g., gentamicin), chloramphenicol, sufonamides (e.g., sulfamethoxazole), glycopeptides (e.g., vancomycin), quinolones (e.g., ciprofloxacin), tetracyclines (e.g., minocycline), fusidic acid, trimethoprim, metronidazole, clindamycin, mupirocin, rifamycins (e.g., rifampin), streptogramins (e.g., quinupristin and dalfopristin) lipoprotein (e.g., daptomycin), polyenes (e.g., amphotericin B), azoles (e.g., fluconazole), and echinocandins (e.g., caspofungin acetate).

Examples of specific antibiotics include, but are not limited to, erythromycin, nafcillin, cefazolin, imipenem, aztreonam, gentamicin, sulfamethoxazole, vancomycin, ciprofloxacin, trimethoprim, rifampin, metronidazole, clindamycin, teicoplanin, mupirocin, azithromycin, clarithromycin, ofloxacin, lomefloxacin, norfloxacin, nalidixic acid, sparfloxacin, pefloxacin, amifloxacin, gatifloxacin, moxifloxacin, gemifloxacin, enoxacin, fleroxacin, minocycline, linezolid, temafloxacin, tosufloxacin, clinafloxacin, sulbactam, clavulanic acid, amphotericin B, fluconazole, itraconazole, ketoconazole, and nystatin. Other examples of antibiotics, such as those listed in Sakamoto et al, U.S. Pat. No. 4,642,104 herein incorporated by reference will readily suggest themselves to those of ordinary skill in the art.

As used herein, the term “protective agent” refers to a composition or compound that protects the activity or integrity of an active agent (e.g., an enzyme, e.g., apyrase) when the active agent is exposed to certain conditions (e.g., drying, freezing). Examples of protective agents include but are not limited to non-fat milk solids, trehalose, glycerol, betaine, sucrose, glucose, lactose, dextran, polyethylene glycol, sorbitol, mannitol, poly vinyl propylene, potassium glutamate, monosodium glutamate, Tween 20 detergent, Tween 80 detergent, and an amino acid hydrochloride.

As used herein, the term “gelling agent” refers to a composition that, when dissolved, suspended or dispersed in a fluid (e.g., an aqueous fluid such as water or a buffer solution), forms a gelatinous semi-solid (e.g., a lubricant gel). Examples of gelling agents include but are not limited to hydroxyethyl cellulose, hydroxymethyl cellulose, hydroxypropyl guar, methyl cellulose, ethyl cellulose, hydroxypropyl cellulose, sodium carboxymethyl cellulose, carbomer, alginate, gelatin, and poloxamer.

As used herein, the term “excipient” refers to an inactive ingredient (i.e. , not pharmaceutically active) added to a preparation of an active ingredient. The gelling and protective agents described herein are referred to generally as “excipients.”

### DETAILED DESCRIPTION OF THE INVENTION

In experiments conducted during the course of developing some embodiments of the present invention, it was found that treatment of biofilm-forming bacterial species (e.g., Acinetobacter spp.) with dATP facilitated biofilm development, while treatment with the ATP-hydrolyzing agent apyrase inhibited biofilm development. Accordingly, in some embodiments, the present invention provides methods, systems, and kits for altering biofilm development (e.g., biofilm initiation, attachment, maturation, dispersion) comprising an agent that affects the level, incidence, or stability of dATP, ATP, an agent or derivative thereof.

In some embodiments, the present invention provides methods, systems, and kits for encouraging or facilitating biofilm formation where such formation is desired. For example, biofilms find industrial use e.g., in water treatment facilities. In some embodiments, therefore, exposure of a biofilm-forming microbe (e.g., biofilm-forming bacteria) to ATP, dATP, derivatives and analogs thereof hastens the formation of the desirable biofilm or enhances desired qualities (e.g., biomass) of the biofilm.

In some embodiments, the present invention provides methods, systems, and kits for discouraging (slowing, eliminating, reducing) the formation of biofilms where such formation is not desired. For example, biofilm formation may undesirable when biofilm-forming microbes colonize or infect patients, e.g., as described herein. Therefore, in some embodiments, exposure of a biofilm-forming microbe (e.g., biofilm-forming bacteria) to an agent that hydrolyzes ATP, dATP, analogs and derivatives thereof prevents the formation of an undesirable biofilm, or lessens undesired qualities (e.g., biomass, structural stability) of the biofilm. In some preferred embodiments, the agent is apyrase.

### Biofilms

A biofilm is an aggregate of microorganisms in which cells adhere to each other and/or to a surface. These adherent cells are frequently embedded within a self-produced matrix of extracellular polymeric substance (EPS). Biofilm EPS, also referred to as slime, is a polymeric conglomeration generally composed of extracellular DNA, proteins, and polysaccharides in various configurations and of various compositions. Biofilms may form on living or non-living surfaces, and represent a prevalent mode of microbial life in natural, industrial and clinical settings. The microbial cells growing in a biofilm are physiologically distinct from planktonic cells of the same organism, which, by contrast, are single cells that may float or swim in a liquid medium.

Microbial biofilms form in response to many factors including but not limited to cellular recognition of specific or non-specific attachment sites on a surface, nutritional cues, or in some cases, by exposure of planktonic cells to sub-inhibitory concentrations of antibiotics. When a cell switches to the biofilm mode of growth, it undergoes a phenotypic shift in behavior in which large suites of genes are differentially regulated.

Although the present invention is not limited by any type of biofilm, biofilm formation typically begins with the attachment of free-floating microorganisms to a surface. These first colonists adhere to the surface initially through weak, reversible Van der Waals forces. If the colonists are not immediately separated from the surface, they can anchor themselves more permanently using cell adhesion structures such as pili.

Initial colonists commonly facilitate the arrival of other cells by providing more diverse adhesion sites and beginning to build the matrix that holds the biofilm together. Some species are not able to attach to a surface on their own but are often able to anchor themselves to the matrix or directly to earlier colonists. It is during this colonization that the cells are able to communicate via quorum sensing, for example, using such compounds as AHL. Once colonization initiates, the biofilm grows through a combination of cell division and recruitment. The final stage of biofilm formation is known as development although herein the terms “formation” and “development” are used interchangeably. In this final stage, the biofilm is established and may only change in shape and size. The development of a biofilm may allow for an aggregate cell colony (or colonies) to be increasingly antibiotic resistant.

Dispersal of cells from the biofilm colony is an essential stage of the biofilm lifecycle. Dispersal enables biofilms to spread and colonize new surfaces. Enzymes that degrade the biofilm extracellular matrix, such as dispersin B and deoxyribonuclease, may play a role in biofilm dispersal (Whitchurch et al. (2002) Science 295:1487; herein incorporated by reference in its entirety). Biofilm matrix degrading enzymes may be useful as anti-biofilm agents (Kaplan et al. (2004) Antimicrobial Agents and Chemotherapy 48 (7): 2633-6; Xavier et al. (2005) Microbiology 151 (Pt 12): 3817-32; each herein incorporated by reference in its entirety). A fatty acid messenger, cis-2-decenoic acid, can induce dispersion and inhibiting growth of biofilm colonies. Secreted by Pseudomonas aeruginosa, this compound induces dispersion in several species of bacteria and the yeast Candida albicans (Davies et al. (2009) Journal of Bacteriology 191 (5): 1393-403; herein incorporated by reference in its entirety).

Biofilms are ubiquitous and are usually found on solid substrates submerged in or exposed to some aqueous solution, although they can form as floating mats on liquid surfaces and also on the surface of leaves, particularly in high humidity climates. Given sufficient resources for growth, a biofilm will quickly grow to be macroscopic. Many types of microbes can form biofilms, e.g., bacteria, archaea, protozoa, fungi and algae. Biofilms may comprise a single type of microbe (monospecies biofilms), or, commonly, multiple types. In some mixed species biofilms, each group performs specialized metabolic functions.

Biofilms form in environments including but not limited to: substrates (e.g., rocks, pebbles) in natural bodies of water (e.g., rivers, pools, streams, oceans, springs); extreme environments (e.g., hot springs including waters with extremely acidic or extremely alkaline pH; frozen glaciers); residential and industrial settings in which solid surfaces are exposed to liquid (e.g., showers, water and sewage pipes, floors and counters in food preparation or processing areas, water-cooling systems, marine engineering systems); hulls and interiors of marine vessels; sewage and water treatment facilities (e.g., water filters, pipes, holding tanks); contaminated waters; within or upon living organisms (e.g., dental plaque, surface colonization or infection of e.g., skin, surfaces of tissues or organs or body cavities or at wound sites; plant epidermis, interior of plants); on the inert surfaces of implanted devices such as catheters, prosthetic cardiac valves, artificial joints, and intrauterine devices; and the like.

Biofilms are involved in a wide variety of microbial infections in the body. Infectious processes in which biofilms have been implicated include but are not limited to urinary tract infections, catheter infections, middle-ear infections, formation of dental plaque and gingivitis, contact lens contamination (Imamura et al. (2008) Antimicrobial Agents and Chemotherapy 52 (1): 171-82; herein incorporated by reference in its entirety), and less common but more lethal processes such as endocarditis, infections in cystic fibrosis, and infections of permanent indwelling devices such as joint prostheses and heart valves (Lewis et al. (2001) Antimicrobial Agents and Chemotherapy 45 (4): 999-1007; Parsek et al. (2003) Annual Review of Microbiology 57: 677-701; each herein incorporated by reference in its entirety). Bacterial biofilms may impair cutaneous wound healing and reduce topical antibacterial efficiency in healing or treating infected skin wounds (Davis et al. (2008) Wound Repair and Regeneration 16 (1): 23-9; herein incorporated by reference in its entirety).

### Acinetobacter

Several species of the genus Acinetobacter have clinical relevance as colonizing and/or pathogenic organisms. For example, Acinetobacter baumannii is a pleomorphic aerobic gram-negative bacillus (similar in appearance to Haemophilus influenzae on Gram stain) commonly isolated from the hospital environment and hospitalized patients. A. baumannii is a water organism and preferentially colonizes aquatic environments. This organism is often cultured from hospitalized patients' sputum or respiratory secretions, wounds, and urine. In a hospital setting, Acinetobacter commonly colonizes irrigating solutions and intravenous solutions. Acinetobacter species have low virulence but are capable of causing infection. Most Acinetobacter isolates recovered from hospitalized patients, particularly those recovered from respiratory secretions and urine, represent colonization rather than infection.

Acinetobacter infections (in contrast to colonizations) usually involve organ systems that have a high fluid content (e.g., respiratory tract, CSF, peritoneal fluid, urinary tract), manifesting as nosocomial pneumonia, infections associated with continuous ambulatory peritoneal dialysis (CAPD), or catheter-associated bacteriuria. The presence of Acinetobacter isolates in respiratory secretions in intubated patients nearly always represents colonization. Acinetobacter pneumonias occur in outbreaks and are usually associated with colonized respiratory-support equipment or fluids. Nosocomial meningitis may occur in colonized neurosurgical patients with external ventricular drainage tubes.

A. baumannii is a multiresistant aerobic gram-negative bacillus sensitive to relatively few antibiotics. Multidrug-resistant Acinetobacter is not a new or emerging phenomenon. Rather, A. baumannii has always been an organism inherently resistant to multiple antibiotics. Drugs to which A. baumannii are often susceptible include Meropenem, Colistin, Polymyxin B, Amikacin, Rifampin, Minocycline, Tigecycline. On the contrary, first-, second-, and third-generation cephalosporins, macrolides, and penicillins have little or no anti-Acinetobacter activity, and their use may actually predispose to Acinetobacter colonization.

### Pharmaceutical Formulations

In some embodiments, agents (e.g., agents affecting the level, incidence, or stability of dATP, ATP, analogs or derivatives thereof; e.g., apyrase) are preferably employed for therapeutic uses in combination with a suitable pharmaceutical carrier. Such compositions comprise an effective amount of the compound, and a pharmaceutically acceptable carrier or excipient. The formulation is made to suit the mode of administration. Pharmaceutically acceptable carriers are determined in part by the particular composition being administered, as well as by the particular method used to administer the composition. Accordingly, there is a wide variety of suitable formulations of pharmaceutical compositions containing the agents, some of which are described herein.

The term “agent” and “compound” are used herein interchangeably. Compounds may be in a formulation for administration topically, locally or systemically in a suitable pharmaceutical carrier. Remington's Pharmaceutical Sciences, 15th Edition by E. W. Martin (Mark Publishing Company, 1975), discloses typical carriers and methods of preparation. The compound may also be encapsulated in suitable biocompatible microcapsules, microparticles or micro spheres formed of biodegradable or non-biodegradable polymers or proteins or liposomes for targeting to cells. Such systems are well known to those skilled in the art and may be optimized for use with the appropriate agent.

In some embodiments, e.g., where agents described herein (e.g., agents affecting the level, incidence, or stability of dATP, ATP, analogs or derivatives thereof; e.g., apyrase) are used topically (e.g., on skin, at wound sites, at burn sites), the agent is preferably formulated for topical application. Formulations for topical administration may include ointments, lotions, creams, gels, drops, suppositories, sprays, liquids and powders. Conventional pharmaceutical carriers, aqueous, powder or oily bases, or thickeners can be used as desired.

Formulations suitable for parenteral administration, such as, for example, by intraarticular (in the joints), intravenous, intramuscular, intradermal, intraperitoneal, and subcutaneous routes, include aqueous and non-aqueous, isotonic sterile injection solutions, which can contain antioxidants, buffers, bacteriostats, and solutes that render the formulation isotonic with the blood of the intended recipient, and aqueous and non-aqueous sterile suspensions, solutions or emulsions that can include suspending agents, solubilizers, thickening agents, dispersing agents, stabilizers, and preservatives. Formulations for injection may be presented in unit dosage form, e.g., in ampules or in multi-dose containers, with an added preservative.

Preparations include sterile aqueous or nonaqueous solutions, suspensions and emulsions, which can be isotonic with the blood of the subject in certain embodiments. Examples of nonaqueous solvents are polypropylene glycol, polyethylene glycol, vegetable oil such as olive oil, sesame oil, coconut oil, arachis oil, peanut oil, mineral oil, injectable organic esters such as ethyl oleate, or fixed oils including synthetic mono- or di-glycerides. Aqueous carriers include water, alcoholic/aqueous solutions, emulsions or suspensions, including saline and buffered media. Parenteral vehicles include sodium chloride solution, 1,3-butandiol, Ringer's dextrose, dextrose and sodium chloride, lactated Ringer's or fixed oils. Intravenous vehicles include fluid and nutrient replenishers, electrolyte replenishers (such as those based on Ringer's dextrose), and the like. Preservatives and other additives may also be present such as, for example, antimicrobials, antioxidants, chelating agents and inert gases and the like. In addition, sterile, fixed oils are conventionally employed as a solvent or suspending medium. For this purpose any bland fixed oil may be employed including synthetic mono- or di-glycerides. In addition, fatty acids such as oleic acid may be used in the preparation of injectables. Carrier formulation can be found in Remington's Pharmaceutical Sciences, Mack Publishing Co., Easton, Pa. Those of skill in the art can readily determine the various parameters for preparing and formulating the compositions without resort to undue experimentation.

The compound alone or in combination with other suitable components, can also be made into aerosol formulations (i.e., they can be “nebulized”) to be administered via inhalation. Aerosol formulations can be placed into pressurized acceptable propellants, such as dichlorodifluoromethane, propane, nitrogen, and the like. For administration by inhalation, the compounds are conveniently delivered in the form of an aerosol spray presentation from pressurized packs or a nebulizer, with the use of a suitable propellant. Similar aerosolized forms may be used for non-pharmaceutical applications, e.g., for spraying or coating inert surfaces.

In some embodiments, the compound described above may include pharmaceutically acceptable carriers with formulation ingredients such as salts, carriers, buffering agents, emulsifiers, diluents, excipients, chelating agents, fillers, drying agents, antioxidants, antimicrobials, preservatives, binding agents, bulking agents, silicas, solubilizers, or stabilizers. In one embodiment, the compounds are conjugated to lipophilic groups like cholesterol and laurie and lithocholic acid derivatives with C32 functionality to improve cellular uptake. Other groups that can be attached or conjugated to agents described herein to increase cellular uptake, include acridine derivatives; cross-linkers such as psoralen derivatives, azidophenacyl, proflavin, and azidoproflavin; artificial endonucleases; metal complexes such as EDTA-Fe(II) and porphyrin-Fe(II); alkylating moieties,; nucleases such as alkaline phosphatase; terminal transferases; abzymes; cholesteryl moieties; lipophilic carriers; peptide conjugates; long chain alcohols; phosphate esters; radioactive markers; non-radioactive markers; carbohydrates; and polylysine or other polyamines.

U.S. Pat. No. 6,919,208 to Levy, et al., herein incorporated by reference, also described methods for enhanced delivery. These pharmaceutical formulations may be manufactured in a manner that is itself known, e.g., by means of conventional mixing, dissolving, granulating, levigating, emulsifying, encapsulating, entrapping or lyophilizing processes.

Compositions can be administered by a number of routes including, but not limited to: oral, intravenous, intraperitoneal, intramuscular, transdermal, subcutaneous, topical, sublingual, or rectal means. Compounds can also be administered via liposomes. Such administration routes and appropriate formulations are generally known to those of skill in the art.

Administration of the formulations described herein may be accomplished by any acceptable method which allows the compound(s) or agent(s) to reach their intended target.

The particular mode selected will depend of course, upon factors such as the particular formulation, the severity of the state of the subject being treated, and the dosage required for therapeutic efficacy. As generally used herein, an “effective amount” is that amount which is able to affect bioform formation or development by a microbe, as compared to a matched sample or microbe not receiving the compound.

The actual effective amounts of compound can vary according to the specific compound or combination thereof being utilized, the particular composition formulated, the mode of administration, and the age, weight, condition of the individual, and severity of the symptoms or condition being treated.

Any acceptable method known to one of ordinary skill in the art may be used to administer a formulation to the subject. The administration may be localized (i.e., to a particular region, physiological system, tissue, organ, or cell type) or systemic, depending on the condition being treated.

Injections can be, e.g., intravenous, intradermal, subcutaneous, intramuscular, or intraperitoneal. The composition can be injected intradermally for treatment or prevention of biofilm development, for example. In some embodiments, the injections can be given at multiple locations. Implantation includes inserting implantable drug delivery systems, e.g., microspheres, hydrogels, polymeric reservoirs, cholesterol matrixes, polymeric systems, e.g., matrix erosion and/or diffusion systems and non-polymeric systems, e.g., compressed, fused, or partially-fused pellets. Inhalation includes administering the composition with an aerosol in an inhaler, either alone or attached to a carrier that can be absorbed. For systemic administration, it may be preferred that the composition is encapsulated in liposomes.

The agent may be delivered in a manner which enables tissue-specific uptake of the agent and/or agent delivery system. Techniques include using tissue or organ localizing devices, such as wound dressings or transdermal delivery systems, using invasive devices such as vascular or urinary catheters, and using interventional devices such as stents having drug delivery capability and configured as expansive devices or stent grafts.

The formulations may be delivered using a bioerodible implant by way of diffusion or by degradation of the polymeric matrix. In certain embodiments, the administration of the formulation may be designed so as to result in sequential exposures to the agent over a certain time period, for example, hours, days, weeks, months or years. This may be accomplished, for example, by repeated administrations of a formulation or by a sustained or controlled release delivery system in which the agent is delivered over a prolonged period without repeated administrations. Administration of the formulations using such a delivery system may be, for example, by oral dosage forms, bolus injections, transdermal patches or subcutaneous implants. Maintaining a substantially constant concentration of the composition may be preferred in some cases.

Other delivery systems suitable include time-release, delayed release, sustained release, or controlled release delivery systems. Such systems may avoid repeated administrations in many cases, increasing convenience to the subject and the physician. Many types of release delivery systems are available and known to those of ordinary skill in the art. They include, for example, polymer-based systems such as polylactic and/or polyglycolic acids, polyanhydrides, polycaprolactones, copolyoxalates, polyesteramides, polyorthoesters, polyhydroxybutyric acid, and/or combinations of these.

Microcapsules of the foregoing polymers are described in, for example, U.S. Pat. No. 5,075,109, herein incorporated by reference. Other examples include nonpolymer systems that are lipid-based including sterols such as cholesterol, cholesterol esters, and fatty acids or neutral fats such as mono-, di- and triglycerides; hydrogel release systems; liposome-based systems; phospholipid based-systems; silastic systems; peptide based systems; wax coatings; compressed tablets using conventional binders and excipients; or partially fused implants. Specific examples include erosional systems in which a composition is contained in a formulation within a matrix (for example, as described in U.S. Pat. Nos. 4,452,775, 4,675,189, 5,736,152, 4,667,013, 4,748,034 and 5,239,660, herein incorporated by reference), or diffusional systems in which an active component controls the release rate (for example, as described in U.S. Pat. Nos. 3,832,253, 3,854,480, 5,133,974 and 5,407,686). The formulation may be as, for example, microspheres, hydrogels, polymeric reservoirs, cholesterol matrices, or polymeric systems. In some embodiments, the system may allow sustained or controlled release of the composition to occur, for example, through control of the diffusion or erosion/degradation rate of the formulation containing the composition. In addition, a pump-based hardware delivery system may be used to deliver one or more embodiments.

Examples of systems in which release occurs in bursts includes, e.g., systems in which the composition is entrapped in liposomes which are encapsulated in a polymer matrix, the liposomes being sensitive to specific stimuli, e.g., temperature, pH, light or a degrading enzyme and systems in which the composition is encapsulated by an ionically-coated microcapsule with a microcapsule core degrading enzyme. Examples of systems in which release of the inhibitor is gradual and continuous include, e.g., erosional systems in which the composition is contained in a form within a matrix and effusional systems in which the composition penetrates at a controlled rate, e.g., through a polymer. Such sustained release systems can be e.g., in the form of pellets, or capsules.

Use of a long-term release implant may be particularly suitable in some embodiments. “Long-term release,” as used herein, means that the implant containing the composition is constructed and arranged to deliver therapeutically effective levels of the composition for at least 30 or 45 days, and preferably at least 60 or 90 days, or even longer in some cases. Long-term release implants are well known to those of ordinary skill in the art, and include some of the release systems described above.

Dosages for a particular individual can be determined by one of ordinary skill in the art using conventional considerations, (e.g. by means of an appropriate, conventional pharmacological protocol). A physician may, for example, prescribe a relatively low dose at first, subsequently increasing the dose until an appropriate response is obtained. The dose administered to an individual is sufficient to effect a beneficial therapeutic response in the individual over time, or, e.g., to reduce symptoms, or other appropriate activity, depending on the application. The dose is determined by the efficacy of the particular formulation, and the activity, stability or serum half-life of the composition employed and the condition of the individual, as well as the body weight or surface area of the individual to be treated. The size of the dose is also determined by the existence, nature, and extent of any adverse side-effects that accompany the administration of a particular compound, formulation, or the like in a particular individual. In non-pharmaceutical applications (e.g., treatment or coating of inert surfaces), the effective amount may similarly be determined by the stability of the composition employed and the condition, e.g., surface area or texture, to be treated, or the environment to which such surface is exposed.

Therapeutic compositions comprising one or more compounds are optionally tested in one or more appropriate in vitro and/or in vivo animal models of disease, to confirm efficacy, tissue metabolism, and to estimate dosages, according to methods well known in the art. In particular, dosages can be initially determined by activity, stability or other suitable measures of treatment vs. non-treatment (e.g., comparison of treated vs. untreated cells or animal models), in a relevant assay. Formulations are administered at a rate determined by the LD₅₀ of the relevant formulation, and/or observation of any side-effects of the nucleic acids at various concentrations, e.g., as applied to the mass and overall health of the individual. Administration can be accomplished via single or divided doses.

In vitro models can be used to determine the effective doses of the compositions as a potential biofilm-affecting treatment. In determining the effective amount of the compound to be administered in the treatment or prophylaxis of disease the physician evaluates circulating plasma levels, formulation toxicities, and progression of the disease or biological state (e.g., biofilm initiation, biofilm development).

The formulations described herein can supplement treatment conditions by any known conventional therapy, including, but not limited to, antibody administration, vaccine administration, administration of cytotoxic agents, natural amino acid polypeptides, nucleic acids, nucleotide analogues, and biologic response modifiers. Two or more combined compounds may be used together or sequentially. For example, compounds can also be administered in therapeutically effective amounts as a portion of an antibiotic, anti-infective, or anti-colonization cocktail.

### EXAMPLES

The following examples are provided in order to demonstrate and further illustrate certain preferred embodiments and aspects of the present invention and are not to be construed as limiting the scope thereof.

### Example 1

Biofilm Growth Affected with dATP or Apyrase Treatment

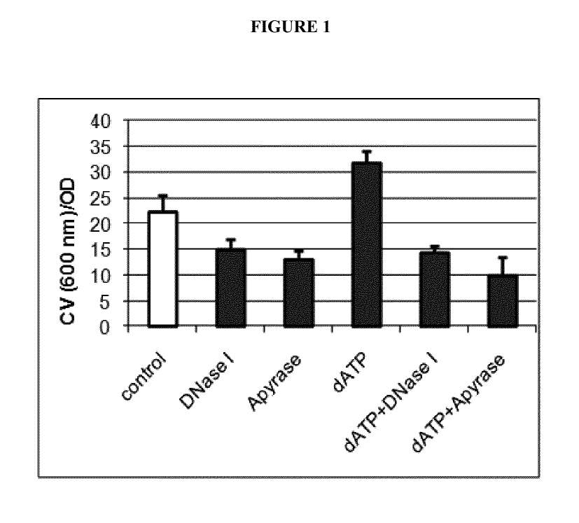

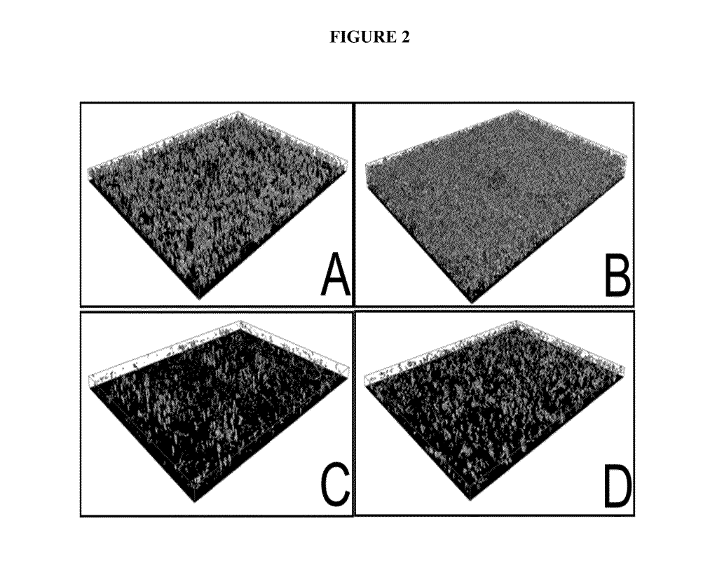

Experiments conducted during the course of developing some embodiments of the present invention showed that treatment with dATP stimulated biofilm biomass (FIGS. 1 and 2). Conversely, treatment with apyrase caused reduced biomass in Acinetobacter biofilms (FIGS. 1 and 2).

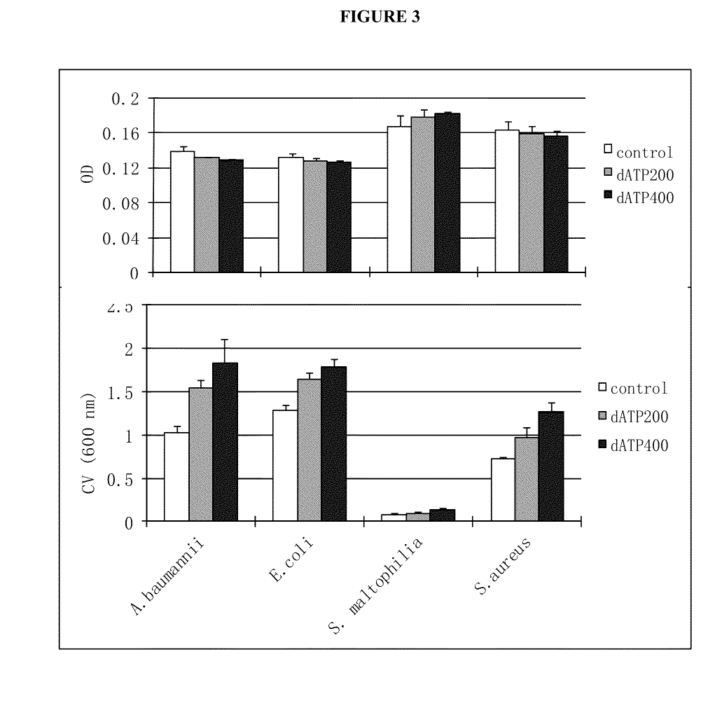

Similarly, treatment of S. aureus, E. coli, and S. maltophilia with 400 μM dATP was correlated with increased biofilm formation (FIG. 3).

Methods:

Overnight LB-grown culture was diluted 100 times with 10% LB medium, and 100 μL of the dilution was inoculated into each well of 96-well plates. dATP, dGTP, DNase I, or apyrase was added into wells to result in the desired concentrations. An equivalent volume of 10% LB medium was added into wells as control. Plates were covered with lids and incubated at 30° C. for 16 hours before optical density (OD) was measured at 600 nm for the record of growth. Fifteen microliters of 0.1% crystal violet solution was added into each well for crystal violet staining (CV staining) After 15 min of staining, each well was washed gently three times with 100 μl of PBS buffer. Supernatant in each well was removed and 100 μl of 75% ethanol was added to dissolve crystal violet before measuring optical density at 600 nm (CV OD) for the quantification of biofilm biomass.

For visualization of biofilm structure (FIG. 2), biofilms were developed as described above. After 16 hours of incubation, supernatant was removed from each well and 100 μl of PBS buffer containing 0.1 mM SYTO-9 green, 10 mM Propidium Iodide (PI) was added for staining in dark for 15 min. Cell images were acquired with a Perkin Elmer UltraView confocal microscope system equipped with an Argon-Krypton laser. Images were taken with an oil immersion 60× objective lens in two channels (488 nm excitation for SYTO9 and 568 nm excitation for PI). 3-D biofilm images were reconstructed with the cell images by using software Amira (Visage Imaging, Inc., San Diego, Calif.).

### Example 2

Effect of dATP Treatment on Attachment, eDNA Release, and Programmed Cell Death in Acinetobacter Biofilms

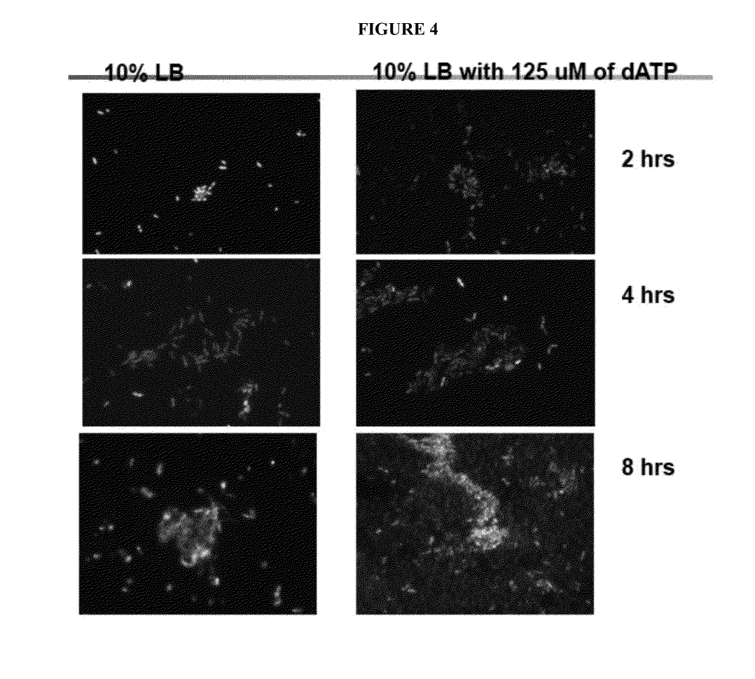

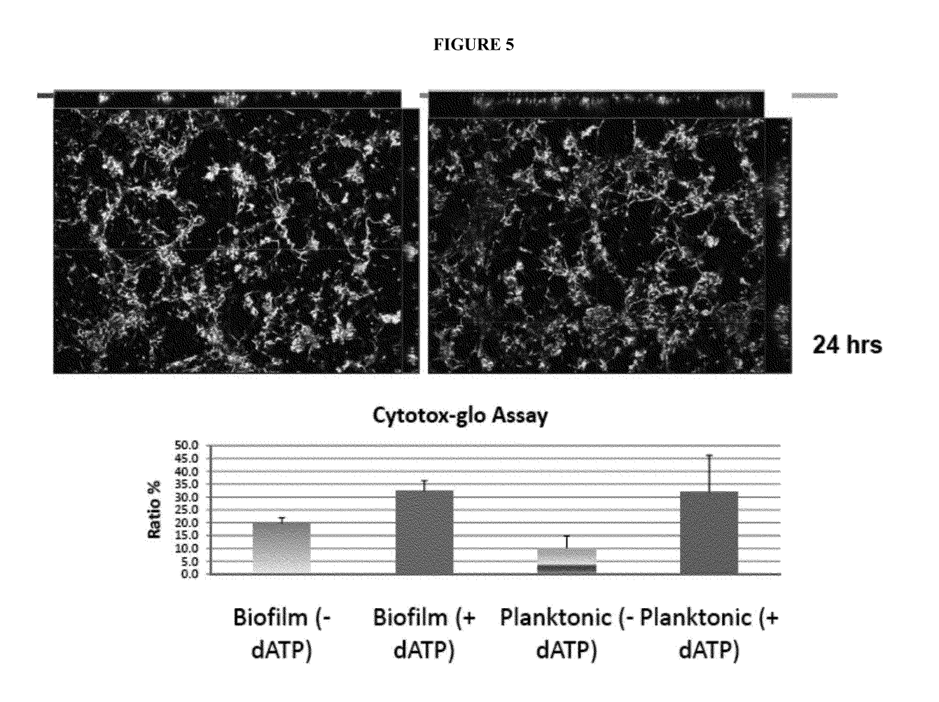

Experiments conducted during the course of developing some embodiments of the present invention showed that treatment of Acinetobacter with 125 μM dATP resulted in accelerated rates of attachment in initial biofilm formation as visualized at 2 h, 4 h, and 8 h post-treatment (FIG. 4). The effect of dATP treatment on programmed cell death in biofilm and planktonic forms of Acinetobacter cultures was also examined. In each, dATP-treated cultures showed increased levels of programmed cell death as measured by Cytotox-glo assays at 24 h post-treatment (FIG. 5).

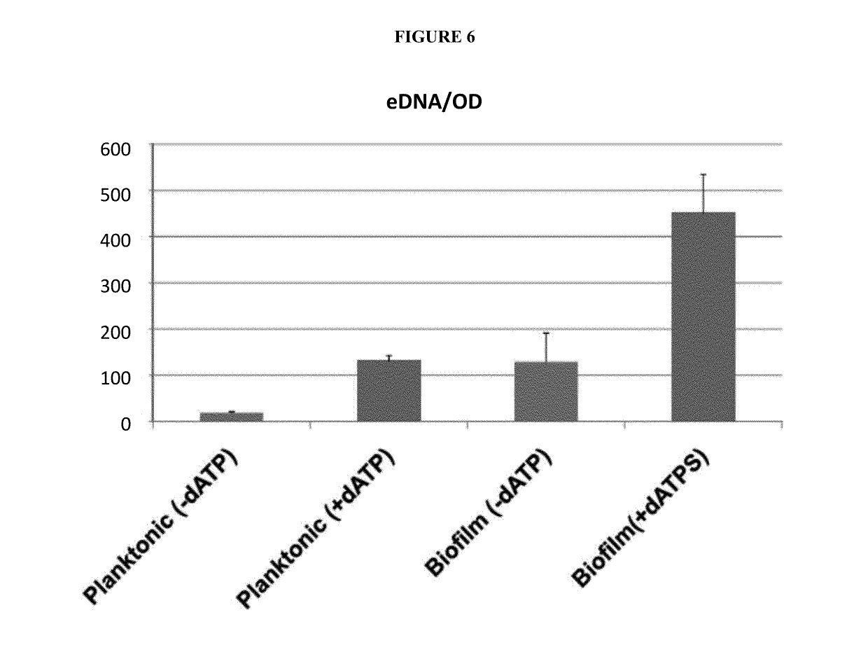

Stimulation of extracellular DNA (eDNA) was also observed following dATP treatment of Acetinobacter in biofilm and planktonic cultures (FIG. 6), with a more pronounced effect occurring in biofilms.

Methods:

Bacterial initial attachment assay: 1% of an overnight culture was inoculated into the wells of 96-well glass bottom microplate containing 100 μl of 10% LB media, after predetermined incubation time, suspension was removed from each well and rinsed with PBS buffer for three times then biofilm samples were stained with LIVE/DEAD BacLight Bacterial Viability Kits (cat. L7007, Invitrogen) following the instructions in the manual. All microscopic observations and image acquisitions were performed with Olympus IX71 equipped with detectors and filter sets for monitoring of SYTO-9 and propidium iodide (PI). Images were obtained using a 60× objective.

DNA extraction and quantification: Biofilms were developed as mentioned above for 16 hours and biofilm cells were resuspended with 0.9% NaCl solution, homogenized for 1 min and utilized for eDNA extraction. Planktonic cells were incubated at 30° C. for 8 hours with a 1% of inoculation and cells were washed with fresh 10% of LB broth three times before resuspension in the same volume of 10% of LB broth or 10% LB broth supplemented with 400 μM of dATP. The cells solutions were then incubated at 30° C. for another 2 hour and were ready for eDNA extraction. Biofilm cells suspension and planktonic cultures were treated as previously reported (27) for DNA extraction. Briefly, cell solution was treated with Dispersin B (20 μg/ml) at 37° C. for 30 min followed by treatment of proteinase K (5 μg/ml) for another 30 min at 37° C. Treated cell solution was filtered through a 0.2 μm syringe filter (PES, Water & Process Technologies), elute was used to extract the extracellular DNA by using ethanol precipitation. DNA was dissolved in 50 μl of sterile MilliQ water and the concentration of DNA was measured by using the PicoGreen dsDNA Quantitation Kit (Molecular Probes, Invitrogen).

Cytotoxicity Assay: Planktonic cells and biofilm cells were collected as described above and washed with PBS buffer three times. Cell concentration was adjusted to 1-1.5×10⁸ CFU/ml with PBS buffer and samples were ready for dead-cell protease activity, which had been released from cells that had lost membrane integrity, by using CytoTox-Glo™ Cytotoxicity Assay (Cat. G9291. Promega. Madison, Wis.) following the instructions by the manufacturer.

### Example 3

Effect of dATP and Apyrase on Acinetobacter baumannii Initial Biofilm Adherence in an In Vitro Cell Culture Model of Human Bronchial Epithelial NCI-H292 Cells

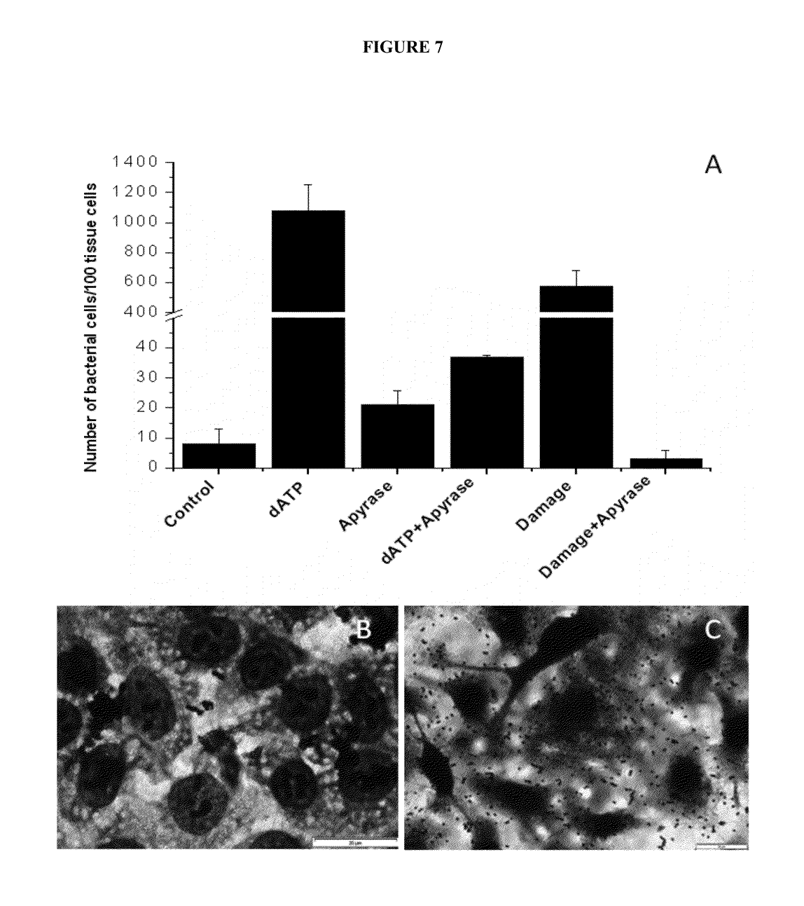

In experiments conducted during the course of developing some embodiments of the present invention, it was found that that supplementing the media with 400 μM of dATP increased A. baumannii adherence about 100-fold (1 hour after incubation) and promoted aggregate formation on human bronchial epithelial cells (FIG. 7). The similar level of increased bacterial adherence was observed when a small portion of human cells were physically damaged (FIG. 7). Increased bacterial adherence was completely arrested by the Apyrase (200 mU/ml) treatment (FIG. 7).

Methods:

Bacterial adherence assay was performed as described (Burnstock (2006) Pharmacol. Rev. 58:58-86; herein incorporated by reference in its entirety). Human bronchial epithelial cell line NCI-H292 (ATCC CRL-1848; American Tissue Culture Collection, Rockville, Md., USA) were cultured in a petri dish at 37° C. in RPMI 1640 medium (Gibco BRL, Grand Island, N.Y., USA), supplemented with 25 mM HEPES, 2 mM L-glutamine, penicillin G 100,000 U/L, streptomycin 50 mg/L and 10% (v/v) of fetal bovine serum (Gibco BRL), in a humidified atmosphere containing 5% (v/v) of CO₂.

When NCI-H292 cells covered about 80% of the bottom of petri dish, the medium was replaced with 0.25% trypsin-EDTA (1689649, MP Biomedicals, Solon Ohio) and the petri dish was incubated at 37° C. for 10 min. NCI-H292 Cells were collected by cell scraper and washed with fresh RPMI 1640 medium three time by centrifuging at 300×g for 3 min. Washed cells were adjusted to the concentration of 1×10⁵ cells per ml with fresh RPMI 1640 and 2 ml of cell solution were transferred to each well of a 12-well plate, which contained a 13-mm-diameter plastic coverslip (Thermanox, Nunc, Rochester, N.Y., USA) in each well. The cells were incubated at 37° C. for about 3 days until cells covered about 90% of coverslip and were then washed with phosphate buffered saline (PBS) three times. Acinetobacter baumannii ATCC 17978 grown overnight in Luria Bertani (LB) medium were collected and washed three times with fresh RPMI 1640 medium by centrifuging at 6,000 rpm for 3 min. Bacterial cells were adjusted to the concentration of 1×10⁸ CFU/mL (OD₆₀₀=0.05) and mixed with reagents (400 μM of dATP, or 200 mU/ml of apyrase) as necessary. Each cell monolayer was infected with 1 mL of bacterial suspension and incubated for 60 min at 37° C. in a CO₂ 5% v/v atmosphere. For damaged cell assays, NCI-H292 cells (around 5%) in the central area of plastic coverslips were damaged by tip of a knife before the infection performed. After infection with Acinetobacter baumannii ATCC 17978, plastic coverslips were washed with PBS buffer three times to remove non-adherent bacteria and then were fixed in 100% of methanol for 20 min before being stained in a Giemsa staining solution for 30 min at room temperature. The coverslips were air-dried, mounted and observed under a light microscope with a ×60 objective lens. The number of bacteria adhering to 100 cells was determined. Three independent experiments were performed for each treatment.

### Example 4

Effect of Apyrase on Acinetobacter baumannii Initial Biofilm Adherence in an In Vivo Mouse Wound Infection Model

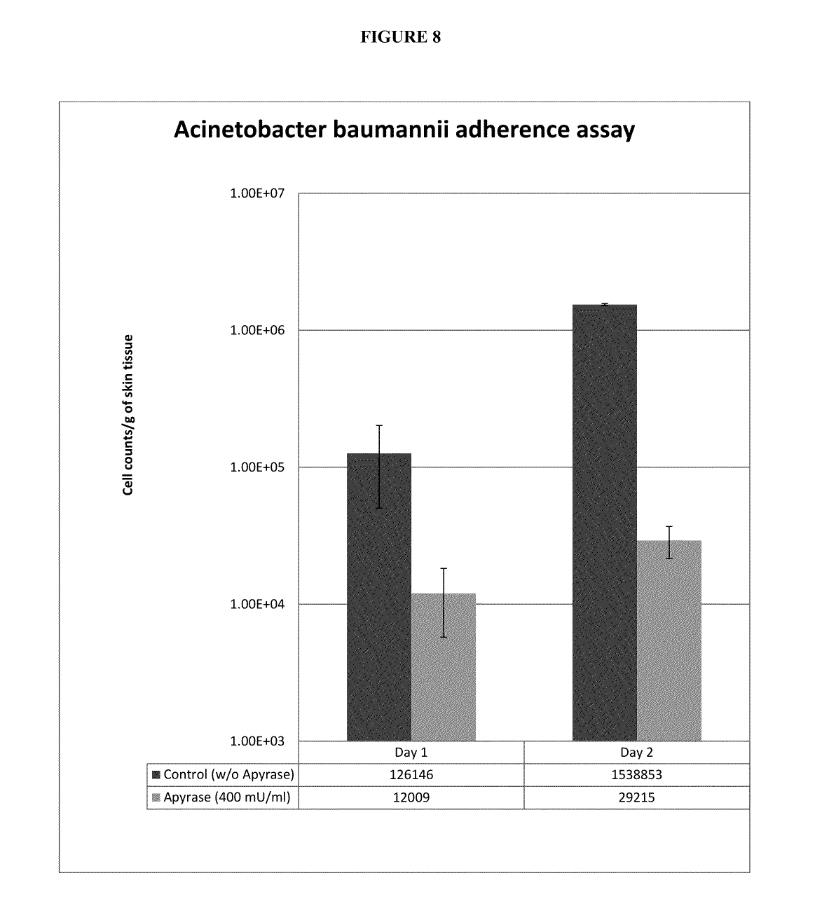

In experiments conducted during the course of developing some embodiments of the present invention, it was found that wound sites treated with 400 mU/mL apyrase during inoculation of the wound with Acinetobacter baumannii showed decreased adherence during initial stages of biofilm formation, as quantified by cell count per gram of skin tissue (FIG. 8).

Methods:

Female pathogen-free C57BL/6 mice (Harlan, Indianapolis, Ind.), 12 weeks old, weighing approximately 20-23 grams were used in all experiments. Mice were housed in standard cages at the University Laboratory Animals Facility and were allowed to acclimate for 7 days after delivery prior to the experiment. The animals were kept on a 12 hour light cycle and were provided with rodent chow (LabDiet 5001, PMI Int'l., Richmond, Ind.) and water ad libitum throughout the study.

Pentobarbital (Nembutal, Ovation Pharmaceuticals, Inc., Deerfield, Ill., manufactured by Hospira, Lake Forest, Ill.) was administered intraperatonially (50 mg/kg IP) for anesthesia. During the study, all mice were singly housed and all received 0.1 mg/kg buprenorphine (Buprenex; Reckitt Benckiser Pharmaceuticals Inc., Richmond, Va.) subcutaneously (SQ) twice daily for post-burn pain control.

The skin over the lumbrosacral and back region was clipped using a 35-W model 5-55E electrical clipper (Oyster-Golden A-S, Head no. 80, blade size 40). Depilatory cream (Nair® lotion) was applied for about 1.5 minutes, then wiped off with a damp paper towel. Skin was rinsed under the faucet in lukewarm water and then blotted dry.

The first buprenorphine dose (67 ul/20 g, 83 ul/25 g mouse or 0.1 ug/g) was administered SQ under the skin of the upper back.

All 8 mice were burned. To create the burn, anesthetized mice were placed in an insulated, custom-made mold which exposes only a lumbrosacral and back region that is approximately 30% of the total body area. Partial thickness burns were achieved by exposure of the skin to 60° C. water for 18 seconds.

Each mouse was given a 1 ml injection of 5% Dextrose and Lactated Ringer's Injection (Abbott Labs NDC 0074-7929-09) IP and another 500 μl injection SQ on the back of its hind leg. Then the eyes were covered with sterile Altalube (Altaire Pharmaceuticals, Aquebogue, N.Y.).

Overnight-grown Acinetobacter baumannii culture was harvested and washed with 0.9% saline three times. The final cell concentration was adjusted to 1×10⁶ CFU/ml with 0.9% saline and was used for inoculation. Either control (inoculums) or treatment (inoculums with 400 mU/ml of apyrase) was applied to each burn in a 200 ul volume.

A sheet of 7 cm×6 cm Tegaderm was cut in half. Mastisol glue was applied to frame the edge, taking care to not get Mastisol on the wound. The burn was completely covered with Tegaderm and wrapped with a 1.5 inch×6 inch bandage, then the ends were gently squeezed to seal. A small slit was cut at both the top and bottom of the ventral side of the bandage to slightly loosen it (taking care not to cut the mouse's skin, and using blunt ended scissors). The cages were placed in a 37° C. incubator (without CO₂ supplementation) with the lid ajar, but leaving the metal screen with the food and water. The door was left ajar so the animals could breathe. Each animal was returned to a fresh cage and to the incubator. Animals remained in the incubator until fully ambulatory. Ambulatory mice were not allowed to remain in the same cage as mice that were still unconscious in order to prevent aggression against the unconscious mice.

The mice removed the Coban within an hour of awakening, but the Tegaderm remained in place. The Coban probably stayed in place long enough for the Mastisol to completely dry.

At 24 hours, the Tegaderm was still attached. Mice were all alert and active.

At the time points for tissue harvest (24 and 48 hours), the mice were given lethal IP injections of pentobarbital (150 mg/kg) and skin samples were collected for RNA isolation, bacteria counts, and for slides/staining The skin was removed with a scalpel and scissors. A small piece of skin was placed in 5 ml of PBS buffer and was homogenized for 1 min. The mixture was diluted serially 10-fold and 50 μl of each dilution was put on LB agar plate for bacteria counts.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in infectious disease, microbiology, bacteriology, or related fields are intended to be within the scope of the following claims.

1-18. (canceled)

19. A method for preventing biofilm formation and/or attachment of biofilm-forming microbes to a non-living surface comprising contacting the surface with an agent that hydrolyzes a compound selected from the group consisting of ATP, dATP, an analog of ATP, and a derivative of ATP under conditions that result in reduction of microbe adhesion.

20. The method of claim 19, wherein said agent is apyrase.

21. The method of claim 19, wherein said microbes are selected from the group consisting of Acinetobacter baylyi, Acinetobacter baumannii, Staphylococcus aureus, Stenotrophomonas maltophilia, and Eschericheria coli.

22. The method of claim 19, wherein said non-living surface is selected from the list consisting of: a medical device, medical tubing, medical instrument, catheter, shunt, ventilator tubing, storage vessel, container, surgical operating surface, food preparation surface, and manufacturing surface.

23. The method of claim 22, wherein said non-living surface is the surface of an indwelling medical device.

24. The method of claim 19, wherein contacting the surface with the agent comprises coating the surface with the agent.

25. The method of claim 19, further comprising contacting a patient with said surface.

26. A non-living surface coated with an agent that hydrolyzes ATP, dATP, an analog of ATP, or a derivative of ATP.

27. The non-living surface of claim 26, wherein said agent is apyrase.

28. The non-living surface of claim 27, wherein said non-living surface is selected from the list consisting of: a medical device, medical tubing, medical instrument, catheter, shunt, ventilator tubing, storage vessel, container, surgical operating surface, food preparation surface, and manufacturing surface.

29. The non-living surface of claim 28, wherein said non-living surface is the surface of an indwelling medical device.
